(19) United States
(12) Patent Application Publication
(10) Pub. No.: US 2015/0073999 A1
(43) Pub. Date: Mar. 12, 2015

(54) METHOD AND SYSTEM FOR CONDUCTING A PAYMENT TRANSACTION AND CORRESPONDING DEVICES

(71) Applicant: MASTERCARD ASIA PACIFIC PTE. LTD., Singapore (SG)

(72) Inventors: Adam Kenneth HOSP, Lake St. Louis, MO (US); Donghao HUANG, Singapore (SG); Jie ZHANG, Singapore (SG); Bensam JOYSON, Singapore (SG)

(73) Assignee: MASTERCARD ASIA PACIFIC PTE. LTD., Singapore (SG)

(21) Appl. No.: 14/482,414

(22) Filed: Sep. 10, 2014

(30) Foreign Application Priority Data
Sep. 10, 2013 (SG) 201306820-0

(51) Int. Cl. G06Q 20/38; G06Q 20/32

(52) U.S. Cl. CPC G06Q 20/38215; G06Q 20/327
USPC 705/76

(57) ABSTRACT

A method includes generating a token at a server device and transmitting the token from the server device to a payer device, the token corresponding to a payment account; receiving the token at the payer device and transmitting the token from the payer device to a payee device via a short-range wireless communication protocol; receiving the token at the payee device and transmitting the token with transaction data from the payee device to the server device, the transaction data corresponding to the payment transaction; and receiving the token with the transaction data at the server device and conducting the payment transaction at the server device using the transaction data and the payment account corresponding to the token.

### FIELD OF INVENTION

The invention relates to a method and system for conducting a payment transaction and corresponding devices.

### BACKGROUND

It is known to provide payment cards to facilitate the performing of transactions electronically. A customer may have one or more payment cards, such as, for example, one or more credit or debit cards. The customer may use one of the payment cards in conjunction with a merchant's device (e.g. an electronic point of sale) to perform a transaction with the merchant. For example, the customer may wish to purchase goods or services from the merchant, and so the customer may use the payment card to transfer funds or payment into the merchant's account in exchange for receiving the goods or services from the merchant. The payment card may be fitted with a Near Field Communication (NFC) interface to enable the payment card to electronically communicate with the merchant's device to perform the transaction.

However, in certain environments or situations, performing payment transactions using NFC may not be desired or feasible. Therefore, there is a need for a method and system for conducting payment transactions that is contactless, secure and does not rely on NFC technology.

### SUMMARY

A first aspect provides a method for conducting a payment transaction using a payee device and a payer device, the payee device and the payer device being capable of communicating with each other via a short-range wireless communication protocol, the payee device and the payer device being in communication with a server device, the method comprising: establishing communication between the payee device and the payer device via the short-range wireless communication protocol; generating a token at the server device and transmitting the token from the server device to the payer device, the token corresponding to a payment account; receiving the token at the payer device and transmitting the token from the payer device to the payee device via the short-range wireless communication protocol; receiving the token at the payee device and transmitting the token with transaction data from the payee device to the server device, the transaction data corresponding to the payment transaction; and receiving the token with the transaction data at the server device and conducting the payment transaction at the server device using the transaction data and the payment account corresponding to the token.

In an embodiment, the payer device transmits the token to the payee device only in response to an input received at the payer device from a user of the payer device.

In an embodiment, the payee device receives the token from the payer device only in response to an input received at the payee device from a user of the payee device.

In an embodiment, the method further comprises: generating a token request at the payer device and transmitting the token request to the server device, the token request identifying the payment account; and wherein the server device receives the token request and generates the token based on the token request.

In an embodiment, the method further comprises: generating a payment acknowledgement at the server device and transmitting the payment acknowledgement to the payee device and/or the payer device, the payment acknowledgement indicating that the transaction has been conducted successfully.

In an embodiment, the payment account is an account of a user of the payer device.

In an embodiment, the server device encrypts the token sent to the payer device, and the server device decrypts the encrypted token received from the payee device.

In an embodiment, the payer device further encrypts the token sent to the payee device, and the payee device decrypts the further encrypted token received from the payer device.

In an embodiment, the transaction data identifies a transaction amount and/or a payee of the transaction.

In an embodiment, the payee is a user of the payee device.

In an embodiment, the server device is configured to conduct only one transaction using the token.

In an embodiment, the server device is configured to conduct the transaction using the token only up to a preset maximum transaction amount.

In an embodiment, the server device comprises a first module and a second module.

In an embodiment, the first module is configured to conduct the transaction.

In an embodiment, the first module is configured to generate the token and transmit the token to the second module; the second module is configured to receive the token from the first module and transmit the token to the payer device.

In an embodiment, short-range is less than 20 meters and, preferably, less than 10 meters.

In an embodiment, the short-range wireless communication protocol is at least one of the following: Apple™ AirDrop™, Bluetooth™, WiFi Ad-Hoc.

A second aspect provides a method comprising: generating a token and transmitting the token to a payer device, the token corresponding to a payment account; and receiving the token with transaction data and conducting a payment transaction using the transaction data and the payment account corresponding to the token.

A third aspect provides a method comprising: establishing communication with a payer device via a short-range wireless communication protocol; and receiving a token and transmitting the token with transaction data to a server device, the token corresponding to a payment account, the transaction data corresponding to a payment transaction.

A fourth aspect provides a method comprising: establishing communication with a payee device via a short-range wireless communication protocol; and receiving a token and transmitting the token to the payee device via the short-range wireless communication protocol, the token corresponding to a payment account.

A fifth aspect provides a system for conducting a payment transaction, the system comprising: a payee device and a payer device capable of communicating with each other via a short-range wireless communication protocol; and a server device capable of communicating with the payee device and the payer device; the system being configured in use to perform at least the following: establish communication between the payee device and the payer device via the short-range wireless communication protocol; generate a token at the server device and transmit the token from the server device to the payer device, the token corresponding to a payment account; receive the token at the payer device and transmit the token from the payer device to the payee device via the short-range wireless communication protocol; receive the token at the payee device and transmit the token with transaction data from the payee device to the server device, the transaction data corresponding to the payment transaction; and receive the token with the transaction data at the server device and conduct the payment transaction at the server device using the transaction data and the payment account corresponding to the token.

In an embodiment, the payer device is configured to transmit the token to the payee device only in response to an input received at the payer device from a user of the payer device.

In an embodiment, the payee device is configured to receive the token from the payer device only in response to an input received at the payee device from a user of the payee device.

In an embodiment, the payer device is configured to generate a token request and transmit the token request to the server device, the token request identifying the payment account; and wherein the server device is configured to receive the token request and generate the token based on the token request.

In an embodiment, the server device is configured to generate a payment acknowledgement and transmit the payment acknowledgement to the payee device and/or the payer device, the payment acknowledgement indicating that the transaction has been conducted successfully.

In an embodiment, the payment account is an account of a user of the payer device.

In an embodiment, the server device is configured to encrypt the token sent to the payer device, and the server device is configured to decrypt the encrypted token received from the payee device.

In an embodiment, the payer device is configured to further encrypt the token sent to the payee device, and the payee device is configured to decrypt the further encrypted token received from the payer device.

In an embodiment, the transaction data identifies a transaction amount and/or a payee of the transaction.

In an embodiment, the payee is a user of the payee device.

In an embodiment, the server device is configured to conduct only one transaction using the token.

In an embodiment, the server device is configured to conduct the transaction using the token only up to a preset maximum transaction amount.

In an embodiment, the server device comprises a first module and a second module.

In an embodiment, the first module is configured to conduct the transaction.

In an embodiment, the first module is configured to generate the token and transmit the token to the second module; the second module is configured to receive the token from the first module and transmit the token to the payer device.

In an embodiment, short-range is less than 20 meters and, preferably, less than 10 meters.

In an embodiment, the short-range wireless communication protocol is at least one of the following: Apple™ AirDrop™, Bluetooth™, WiFi Ad-Hoc.

A sixth aspect provides a device comprising: at least one processor; and at least one memory including computer program code, the at least one memory and the computer program code configured to, with the at least one processor, cause the device at least to: generate a token and transmit the token to a payer device, the token corresponding to a payment account; and receive the token with transaction data and conduct a payment transaction using the transaction data and the payment account corresponding to the token.

A seventh aspect provides a device comprising: at least one processor; and at least one memory including computer program code, the at least one memory and the computer program code configured to, with the at least one processor, cause the device at least to: establish communication with a payer device via a short-range wireless communication protocol; and receive a token and transmit the token with transaction data to a server device, the token corresponding to a payment account, the transaction data corresponding to a payment transaction.

An eighth aspect provides a device comprising: at least one processor; and at least one memory including computer program code, the at least one memory and the computer program code configured to, with the at least one processor, cause the device at least to: establish communication with a payee device via a short-range wireless communication protocol; and receive a token and transmit the token to the payee device via the short-range wireless communication protocol, the token corresponding to a payment account.

### BRIEF DESCRIPTION OF THE DRAWINGS

Example embodiments of the invention will be better understood and readily apparent to one of ordinary skill in the art from the following written description, by way of example only, and in conjunction with the drawings, in which:

FIG. 1 is a flow chart illustrating a method for conducting a payment transaction, according to an example embodiment of the present invention;

FIG. 2 is an architecture diagram of a system for conducting a payment transaction, according to an embodiment of the present invention;

FIGS. 3A and 3B together show a sequence diagram of a method for conducting a payment transaction, according to an embodiment of the present invention; and

FIG. 4 is a schematic diagram of a computer system for implementing the system and method for conducting a payment transaction in example embodiments of the present invention.

### DETAILED DESCRIPTION

Embodiments of the present invention will be described with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods disclosed herein. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM, GPRS, 3G or 4G mobile telephone systems. The computer program when loaded and executed on such a general-purpose computer effectively results in an apparatus that implements the steps of the preferred method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

According to an embodiment of the present invention, there is provided a method for conducting a payment transaction using a payee device and a payer device, the payee device and the payer device being capable of communicating with each other via a short-range wireless communication protocol. The short-range wireless communication protocol can be at least one of the following: Apple™ AirDrop™, Bluetooth™, WiFi Ad-Hoc. In an embodiment, short-range is less than 20 meters. In another embodiment, short-range is less than 10 meters. Further, the payee device and the payer device are in communication with a server device.

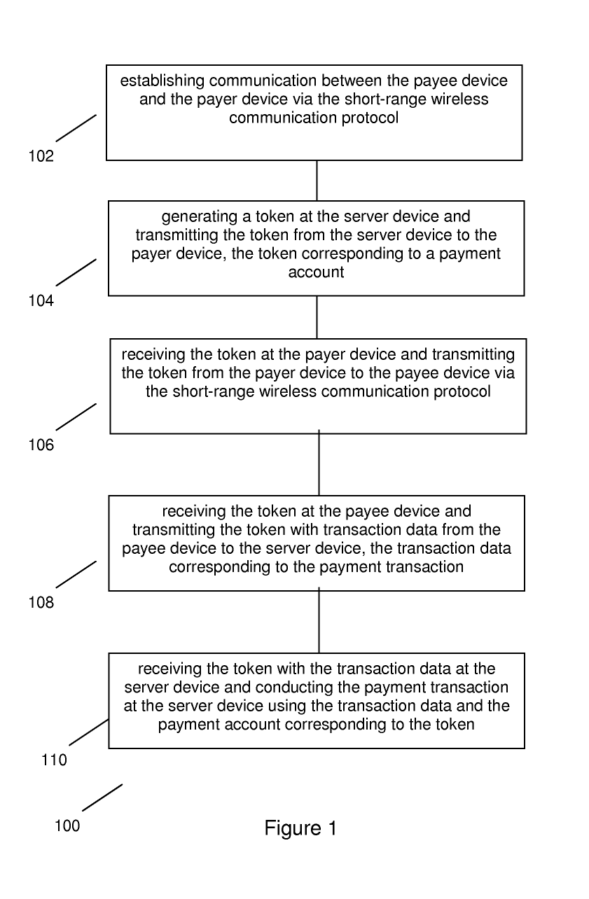

With reference to FIG. 1, the method 100 for conducting the payment transaction comprises the following steps. However, the steps are not necessarily in the following order.

At step 102: Communication is established between the payee device and the payer device via the short-range wireless communication protocol.

At step 104: A token is generated at the server device, and the token is transmitted from the server device to the payer device. The token corresponds to a payment account.

In an embodiment, a token is a data packet (i.e. portion of data) which corresponds to a payment account, such as, for example, a bank account. The token may include a reference or identifier of the payment account and thereby correspond with the payment account. In an embodiment, the token may not include any details of the account, for example, an account number, an account holder's details (e.g. name or address), the amount of funds in the account. Accordingly, the token cannot be used by a malicious party to extract unlimited funds. However, the token may be used by a party in possession of the token to remove certain funds from the account. In an embodiment, a given token may be used only a certain number of times to extract funds, e.g. one time or two times. The token may be considered a one-time token. In an embodiment, a given token may be used to extract a specific amount (e.g. $100) or an amount up to a specific threshold (e.g. up to $100). In an embodiment, the token may be used to extract money by only specific parties, e.g. only one or only two specific parties. In this case, the token may specify which parties may use the token to extract funds from the corresponding account. Such tokens may be described as user-specific tokens or specific tokens. In another embodiment, the token may be used to extract money by any party which is in possession of the token. In this case, the token may be described as a user-generic token or a generic token.

At step 106: The token is received at the payer device; and the token is transmitted from the payer device to the payee device via the short-range wireless communication protocol.

At step 108: The token is received at the payee device; and the token, with transaction data, is transmitted from the payee device to the server device. The transaction data corresponds to the payment transaction.

At step 110: The token, with the transaction data, is received at the server device. The payment transaction is conducted at the server device using the transaction data and the payment account corresponding to the token.

The payer device preferably transmits the token to the payee device only in response to an input received from a user of the payer device. Also, the payee device preferably receives the token from the payer device only in response to an input received at the payee device from a user of the payee device. In other words, user input is required in order to conduct the payment transaction. Accordingly, the payee device and/or the payer device may comprise an input means, such as a keypad or a touch screen. In use, a user of the payee device and/or the payer device may control its respective input means to provide an input to the respective device.

The method may further comprise the steps of: generating a token request at the payer device and transmitting the token request to the server device. The token request identifies the payment account; and the server device receives the token request and generates the token based on the token request.

The method may further comprise the steps of: generating a payment acknowledgement at the server device and transmitting the payment acknowledgement to the payee device and/or the payer device, the payment acknowledgement indicating that the transaction has been conducted successfully.

The payment account may be an account (e.g. a bank account) of a user of the payer device.

In an example embodiment, for added security, the server device encrypts the token sent to the payer device, and the server device decrypts the encrypted token received from the payee device. In addition, the payer device may further encrypt the token sent to the payee device, and the payee device may decrypt the further encrypted token received from the payer device. Accordingly, two phases of encryption may be provided.

The transaction data may identify a transaction amount and/or a payee of the transaction. Further, the payee may be a user of the payee device.

For added security, the server device may be configured to conduct only one transaction using the token. The server device may also be configured to conduct the transaction using the token only up to a preset condition, for example, a predetermined maximum transaction amount (e.g. $100).

The server device may comprise a first module and a second module. The first module may be configured to generate the token, transmit the token to the second module, and conduct the transaction. The second module may be configured to receive the token from the first module and transmit the token to the payer device.

According to another embodiment of the present invention, there is provided a system for conducting a payment transaction, the system comprising: a payee device and a payer device capable of communicating with each other via a short-range wireless communication protocol; and a server device capable of communicating with the payee device and the payer device.

The system is configured in use to perform at least the following: establish communication between the payee device and the payer device via the short-range wireless communication protocol; generate a token at the server device and transmitting the token from the server device to the payer device, the token corresponding to a payment account; receive the token at the payer device and transmitting the token from the payer device to the payee device via the short-range wireless communication protocol; receive the token at the payee device and transmitting the token with transaction data from the payee device to the server device, the transaction data corresponding to the payment transaction; and receive the token with the transaction data at the server device and conducting the payment transaction at the server device using the transaction data and the payment account corresponding to the token.

The payer device may be configured to transmit the token to the payee device only in response to an input received at the payee device from a user of the payer device.

The payee device may be configured to receive the token from the payer device only in response to an input received at the payee device from a user of the payee device.

The payer device may be configured to generate a token request and transmit the token request to the server device, the token request identifying the payment account. The server device may be configured to receive the token request and generate the token based on the token request.

The server device may be configured to generate a payment acknowledgement and transmit the payment acknowledgement to the payee device and/or the payer device, the payment acknowledgement indicating that the transaction has been conducted successfully.

The server device may be configured to encrypt the token sent to the payer device, and the server device may be configured to decrypt the encrypted token received from the payee device. In addition, the payer device may be configured to further encrypt the token sent to the payee device, and the payee device may be configured to decrypt the further encrypted token received from the payer device.

The server device may be configured to conduct only one transaction using the token. The server device may be configured to conduct the transaction using the token only up to a preset condition.

The server device may comprise a first module and a second module. The first module may be configured to generate the token, transmit the token to the second module, and conduct the transaction. The second module may be configured to receive the token from the first module and transmit the token to the payer device.

In an embodiment, the server device comprises: at least one processor; and at least one memory including computer program code. The at least one memory and the computer program code are configured to, with the at least one processor, cause the device at least to: generate a token and transmit the token to a payer device, the token corresponding to a payment account; and receive the token with transaction data and conduct a payment transaction using the transaction data and the payment account corresponding to the token.

In an embodiment, the payee device comprises: at least one processor; and at least one memory including computer program code. The at least one memory and the computer program code are configured to, with the at least one processor, cause the device at least to: establish communication with a payer device via a short-range wireless communication protocol; and receive a token and transmit the token with transaction data to a server device, the token corresponding to a payment account, the transaction data corresponding to a payment transaction.

In an embodiment, the payer device comprises: at least one processor; and at least one memory including computer program code. The at least one memory and the computer program code are configured to, with the at least one processor, cause the device at least to: establish communication with a payee device via a short-range wireless communication protocol; and receive a token and transmit the token to the payee device via the short-range wireless communication protocol, the token corresponding to a payment account.

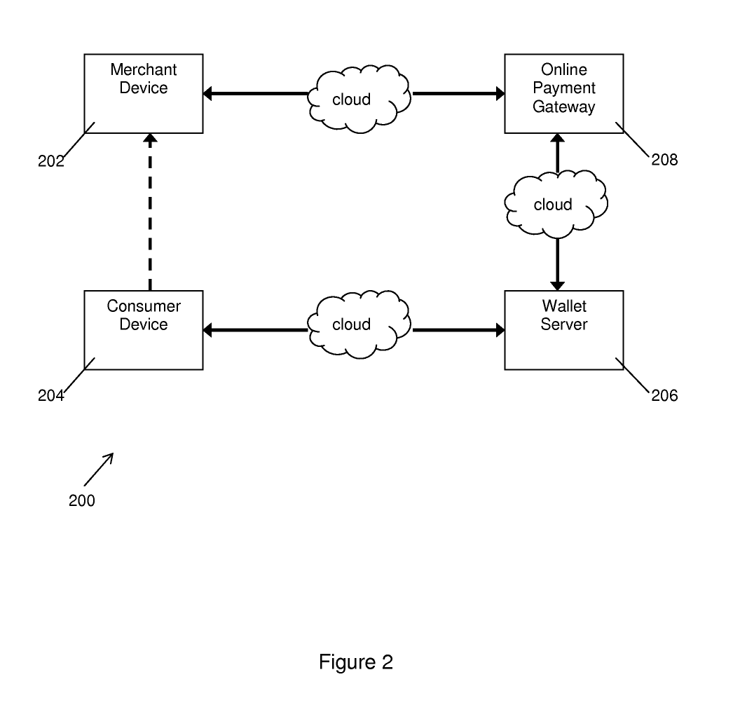

FIG. 2 is an architecture diagram of a system 200 for conducting a payment transaction, according to an example embodiment of the present invention. The system 200 comprises a merchant device 202, a consumer device 204, a wallet server 206 and an online payment gateway (or server) 208. In the payment transaction, a merchant (who is using the merchant device 202) is selling good(s) and/or service(s) to the consumer (who is using the consumer device 204) in exchange for money. In this context, the consumer is a payer and the merchant is a payee; and therefore, the merchant device 202 can be thought of as a payee device and the consumer device 204 can be thought of as a payer device.

The merchant device 202 and the consumer device 204 are capable of communicating with each other via a short-range wireless communication protocol, e.g. Apple™ AirDrop™ or a similar short-range wireless communication protocol as will be known to persons skilled in the art. The wallet server 206 and the online payment gateway 208 are capable of communicating with the merchant device 202 and the consumer device 204 by any suitable means known in the art. The means may be wired and/or wireless.

The online payment gateway 208 may be configured to generate a token, transmit the token to the wallet server 206, and conduct the payment transaction. The wallet server 206 may be configured to receive the token from the online payment gateway 208 and transmit the token to the consumer device 204.

It will be appreciated that the wallet server 206 and the online payment gateway 208 can be implemented using one computer server, or may be implemented using more than one computer server. If one computer server is used, the server is configured to independently act as the wallet server 206 and the online payment gateway 208.

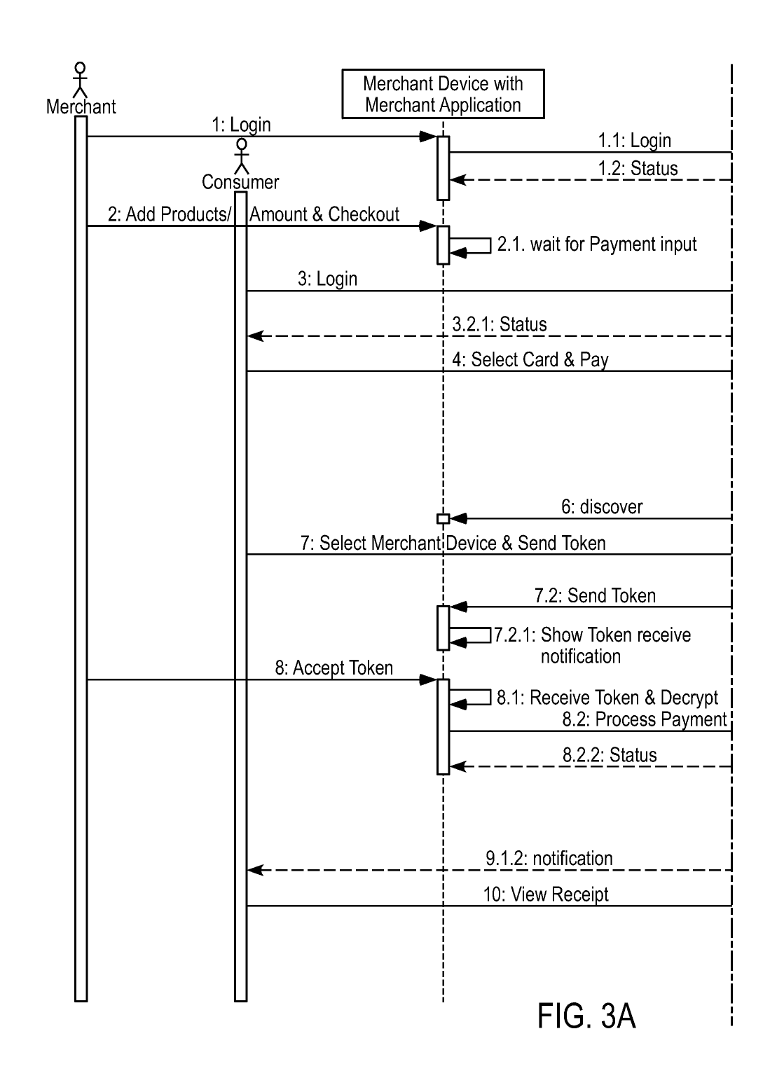

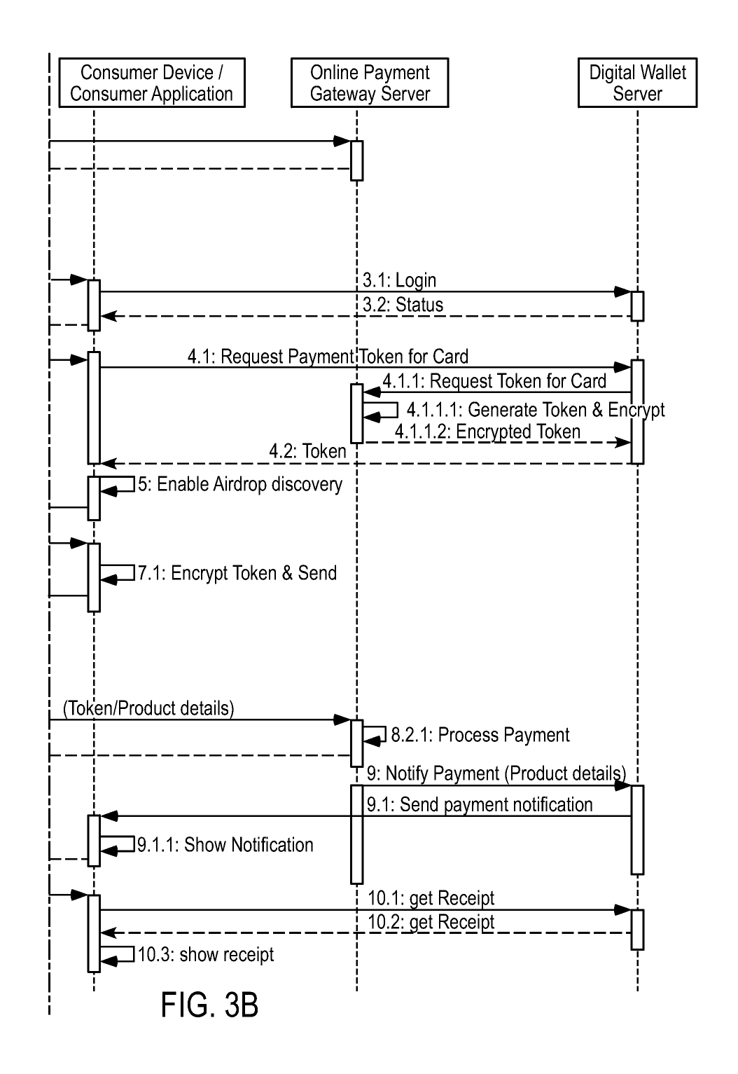

FIGS. 3A and 3B together show a flow chart illustrating a method for conducting a payment transaction, according to an example embodiment of the present invention. In the payment transaction, a merchant (who is using a merchant device) is selling good(s) and/or service(s) to the consumer (who is using a consumer device) in exchange for money. In this context, the consumer is a payer and the merchant is a payee; and therefore, the merchant device (with a suitable merchant application installed thereon) can be thought of as a payee device and the consumer device (with a suitable consumer application installed thereon) can be thought of as a payer device. The merchant device and the consumer device are capable of communicating with each other via a short-range wireless communication protocol. A digital wallet server and an online payment gateway are capable of communicating with the merchant device and the consumer device.

At step 1, the merchant logs in to the merchant application that is installed on the merchant device. The online payment gateway server, which is connected to the merchant device, verifies the login credentials of the merchant (step 1.1). Upon successful authentication, the online payment gateway sends a notification to the merchant device to notify the merchant of successful login (step 1.2)

At step 2, supposing a consumer has selected some good(s) and/or service(s) to be purchased from the merchant, the merchant takes note of the selected good(s) and/or service(s), calculates the total cost, and initiates checkout using the merchant application. At this juncture, the merchant application waits for payment input (step 2.1).

The merchant informs the consumer that he can proceed to pay for his purchases. The consumer then logs in to the consumer application that is installed on the consumer device. At step 3.1, the digital wallet server, which is connected to the consumer device, verifies the login credentials of the consumer. Upon successful authentication, the digital wallet server sends a notification to the consumer device to notify the consumer of successful login (step 3.2 and 3.2.1).

At step 4, upon receipt of the notification, the consumer can virtually choose a card (e.g., credit, debit or pre-paid) to pay for his purchases. Once he has selected the card to be used, he can initiate payment by providing an input (e.g. pressing a “Pay” button on the consumer application). At step 4.1, the consumer application transmits a request to the digital wallet server to obtain a token. At step 4.1.1, the digital wallet server transmits the request to the online payment gateway to generate the token. At step 4.1.1.1, the online payment gateway generates the token which corresponds to a payment account linked to the selected card. Optionally, for added security, the online payment gateway can encrypt the token. At step 4.1.1.2, the (encrypted) token is transmitted to the digital wallet server. At step 4.2, the digital wallet server transmits the token to the consumer device.

At step 5, the consumer application initiates discovery of the merchant device via a suitable wireless communication protocol, such as Apple™ AirDrop™. At step 6, the consumer device discovers the merchant device. It is possible that more than one merchant device may be discovered. For example, a merchant can have more than one checkout counter, and each checkout counter has a respective merchant device. It is also possible that neighboring merchant devices that are within range are discovered.

At step 7, the consumer selects the correct merchant device from the list of discovered devices. At step 7.1, the consumer device may further encrypt the token that is received from the digital wallet server in step 4.2. At step 7.2, the consumer device pushes the (further encrypted) token to the merchant device. A step 7.2.1, the merchant device generates a notification to notify the merchant that the token is waiting to be sent. At step 8, the user provides a suitable input in the merchant application (e.g. “Accept payment”) and the merchant device accepts the token.

At step 8.1, the merchant device receives the token and decrypts the token (i.e. first stage of decryption). At step 8.2, the merchant device sends the decrypted token and transaction data to the online payment gateway server. The transaction data may identify the good(s) and service(s) purchased, the transaction amount, and/or payee of the transaction. At step 8.2.1, the online payment gateway server decrypts the token (i.e. second stage of decryption) and processes the payment. At step 8.2.2, the online payment gateway server transmits a notification (e.g. a payment acknowledgement) to the merchant device to indicate the transaction is complete and successful.

At step 9, the online payment gateway server transmits the transaction data to the digital wallet server. At step 9.1, the digital wallet server transmits a payment acknowledgement to the consumer device, the payment acknowledgement containing transaction data and an acknowledgement notification. At step 9.1.1, the payment acknowledgement is displayed on the consumer application so that a consumer can be notified accordingly (step 9.1.2).

Optionally, at step 10, the consumer can choose to view a receipt of the transaction. If so, at step 10.1, the consumer device sends a request to the digital wallet server to obtain a receipt. At step 10.2, the digital wallet server generates the receipt and transmits the receipt to the consumer device. At step 10.3, the receipt is displayed on the consumer application.

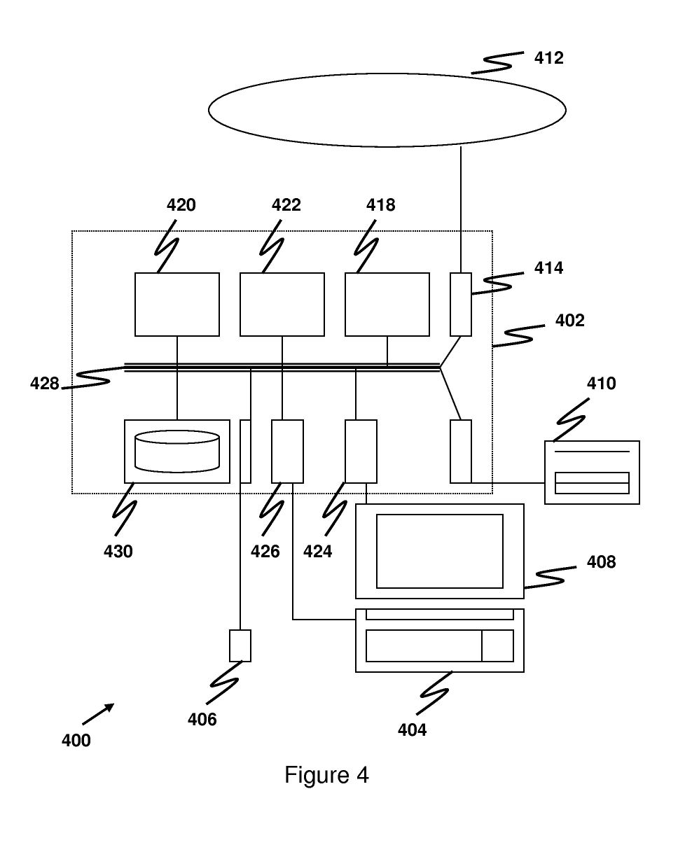

The method(s), system(s) and devices of the example embodiments can be implemented on a computer system 400, schematically shown in FIG. 4. It may be implemented as software, such as a computer program being executed within the computer system 400, and instructing the computer system 400 to conduct the method of the example embodiment.

The computer system 400 comprises a computer module 402, input modules such as a keyboard 404 and mouse 406 and a plurality of output devices such as a display 408, and printer 410.

The computer module 402 is connected to a computer network 412 via a suitable transceiver device 414, to enable access to e.g. the Internet or other network systems such as Local Area Network (LAN) or Wide Area Network (WAN).

The computer module 402 in the example includes a processor 418, a Random Access Memory (RAM) 420 and a Read Only Memory (ROM) 422. The computer module 402 also includes a number of Input/Output (I/O) interfaces, for example I/O interface 424 to the display 408, and I/O interface 426 to the keyboard 404.

The components of the computer module 402 typically communicate via an interconnected bus 428 and in a manner known to the person skilled in the relevant art.

The application program is typically supplied to the user of the computer system 400 encoded on a data storage medium such as a CD-ROM or flash memory carrier and read utilizing a corresponding data storage medium drive of a data storage device 430. The application program is read and controlled in its execution by the processor 418. Intermediate storage of program data may be accomplished using RAM 420.

In some embodiments the computer system 400 may be miniaturized so as to fit inside a hand-held casing. In this case, the input modules maybe limited to a touch screen and/or a keypad. The printer may be omitted. Furthermore, a wireless transceiver device may be provided for communicating with other electronic devices and systems.

It will be appreciated by a person skilled in the art that numerous variations and/or modifications may be made to the present invention as shown in the embodiments without departing from a spirit or scope of the invention as broadly described. The embodiments are, therefore, to be considered in all respects to be illustrative and not restrictive.

What is claimed is:

1. A method for conducting a payment transaction using a payee device and a payer device, the payee device and the payer device being capable of communicating with each other via a short-range wireless communication protocol, the payee device and the payer device being in communication with a server device, the method comprising:
a. establishing communication between the payee device and the payer device via the short-range wireless communication protocol;
b. generating a token at the server device and transmitting the token from the server device to the payer device, the token corresponding to a payment account;
c. receiving the token at the payer device and transmitting the token from the payer device to the payee device via the short-range wireless communication protocol;
d. receiving the token at the payee device and transmitting the token with transaction data from the payee device to the server device, the transaction data corresponding to the payment transaction; and
e. receiving the token with the transaction data at the server device and conducting the payment transaction at the server device using the transaction data and the payment account corresponding to the token.

2. The method of claim 1, wherein the payer device transmits the token to the payee device only in response to an input received at the payer device from a user of the payer device.

3. The method of claim 1, wherein the payee device receives the token from the payer device only in response to an input received at the payee device from a user of the payee device.

4. The method of claim 1, further comprising: generating a token request at the payer device and transmitting the token request to the server device, the token request identifying the payment account; and wherein the server device receives the token request and generates the token based on the token request.

5. The method of claim 1, further comprising: generating a payment acknowledgement at the server device and transmitting the payment acknowledgement to the payee device and/or the payer device, the payment acknowledgement indicating that the transaction has been conducted successfully.

6. The method of claim 1, wherein the payment account is an account of a user of the payer device.

7. The method of claim 1, wherein the server device encrypts the token sent to the payer device, and the server device decrypts the encrypted token received from the payee device.

8. The method of claim 7, wherein the payer device further encrypts the token sent to the payee device, and the payee device decrypts the further encrypted token received from the payer device.

9. The method of claim 1, wherein the transaction data identifies a transaction amount and/or a payee of the transaction.

10. The method of claim 9, wherein the payee is a user of the payee device.

11. The method of claim 1, wherein the server device is configured to conduct only one transaction using the token.

12. The method of claim 1, wherein the server device is configured to conduct the transaction using the token only up to a preset maximum transaction amount.

13. The method of claim 1, wherein the server device comprises a first module and a second module.

14. The method of claim 13, wherein the first module is configured to conduct the transaction.

15. The method of claim 13, wherein the first module is configured to generate the token and transmit the token to the second module; the second module is configured to receive the token from the first module and transmit the token to the payer device.

16. The method of claim 1, wherein short-range is less than 20 meters and, preferably, less than 10 meters.

17. The method of claim 1, wherein the short-range wireless communication protocol is at least one of the following: Apple™ AirDrop™, Bluetooth™, WiFi Ad-Hoc.

18. A method comprising:
generating a token and transmitting the token to a payer device, the token corresponding to a payment account; and
receiving the token with transaction data and conducting a payment transaction using the transaction data and the payment account corresponding to the token.

19. A method comprising:
establishing communication with a payer device via a short-range wireless communication protocol; and
receiving a token and transmitting the token with transaction data to a server device, the token corresponding to a payment account, the transaction data corresponding to a payment transaction.

20. A method comprising:
establishing communication with a payee device via a short-range wireless communication protocol; and
receiving a token and transmitting the token to the payee device via the short-range wireless communication protocol, the token corresponding to a payment account.

21. A system for conducting a payment transaction, the system comprising:
a payee device and a payer device capable of communicating with each other via a short-range wireless communication protocol; and
a server device capable of communicating with the payee device and the payer device;
the system being configured in use to perform at least the following:
establish communication between the payee device and the payer device via the short-range wireless communication protocol;
generate a token at the server device and transmit the token from the server device to the payer device, the token corresponding to a payment account;
receive the token at the payer device and transmit the token from the payer device to the payee device via the short-range wireless communication protocol;
receive the token at the payee device and transmit the token with transaction data from the payee device to the server device, the transaction data corresponding to the payment transaction; and
receive the token with the transaction data at the server device and conduct the payment transaction at the server device using the transaction data and the payment account corresponding to the token.

22. The system of claim 21, wherein the payer device is configured to transmit the token to the payee device only in response to an input received at the payer device from a user of the payer device.

23. The system of claim 21, wherein the payee device is configured to receive the token from the payer device only in response to an input received at the payee device from a user of the payee device.

24. The system of claim 21, wherein the payer device is configured to generate a token request and transmit the token request to the server device, the token request identifying the payment account; and wherein the server device is configured to receive the token request and generate the token based on the token request.

25. The system of claim 21, wherein the server device is configured to generate a payment acknowledgement and transmit the payment acknowledgement to the payee device and/or the payer device, the payment acknowledgement indicating that the transaction has been conducted successfully.

26. The system of claims 21, wherein the payment account is an account of a user of the payer device.

27. The system of claim 21, wherein the server device is configured to encrypt the token sent to the payer device, and the server device is configured to decrypt the encrypted token received from the payee device.

28. The system of claim 27, wherein the payer device is configured to further encrypt the token sent to the payee device, and the payee device is configured to decrypt the further encrypted token received from the payer device.

29. The system of claim 21, wherein the transaction data identifies a transaction amount and/or a payee of the transaction.

30. The system of claim 29, wherein the payee is a user of the payee device.

31. The system of claim 21, wherein the server device is configured to conduct only one transaction using the token.

32. The system of claim 21, wherein the server device is configured to conduct the transaction using the token only up to a preset maximum transaction amount.

33. The system of claim 21, wherein the server device comprises a first module and a second module.

34. The system of claim 33, wherein the first module is configured to conduct the transaction.

35. The system of claim 33, wherein the first module is configured to generate the token and transmit the token to the second module; the second module is configured to receive the token from the first module and transmit the token to the payer device.

36. The system of claim 21, wherein short-range is less than 20 meters and, preferably, less than 10 meters.

37. The system of claim 21, wherein the short-range wireless communication protocol is at least one of the following: Apple™ AirDrop™, Bluetooth™, WiFi Ad-Hoc.

38. A device comprising:
at least one processor; and
at least one memory including computer program code,
the at least one memory and the computer program code configured to, with the at least one processor, cause the device at least to:
generate a token and transmit the token to a payer device, the token corresponding to a payment account; and
receive the token with transaction data and conduct a payment transaction using the transaction data and the payment account corresponding to the token.

39. A device comprising:
at least one processor; and
at least one memory including computer program code,
the at least one memory and the computer program code configured to, with the at least one processor, cause the device at least to:
establish communication with a payer device via a short-range wireless communication protocol; and
receive a token and transmit the token with transaction data to a server device, the token corresponding to a payment account, the transaction data corresponding to a payment transaction.

40. A device comprising:
at least one processor; and
at least one memory including computer program code,
the at least one memory and the computer program code configured to, with the at least one processor, cause the device at least to:
establish communication with a payee device via a short-range wireless communication protocol; and
receive a token and transmit the token to the payee device via the short-range wireless communication protocol, the token corresponding to a payment account.
